(19) United States
(12) Patent Application Publication
(10) Pub. No.: US 2012/0319951 A1
(43) Pub. Date: Dec. 20, 2012

(54) APPARATUS AND METHOD OF MULTI-INPUT AND MULTI-OUTPUT USING A MOBILE COMMUNICATION TERMINAL

(75) Inventor: Sang Hoon Lee, Gwanju (KR)

(73) Assignee: AQ CO., LTD., Seoul (KR)

(21) Appl. No.: 13/581,610

(22) PCT Filed: Mar. 11, 2011
(86) PCT No.: PCT/KR2011/001699

§ 371 Date: Aug. 28, 2012

(30) Foreign Application Priority Data
Mar. 12, 2010 (KR) 10-2010-0022201

(51) Int. Cl. G06F 3/033

(52) U.S. Cl. 345/161; 345/156; 345/173

(57) ABSTRACT

A multi input control window in one-to-one correspondence with an external information device can be programmed and activated in the mobile communication terminal in diverse ways through a multi input mode application unit, depending on the type of a multi-input operation. Also, a first input signal with respect to a touch screen, a second input signal with respect to an acceleration sensor, and a third input signal based on the location of a mobile communication terminal that moves in the X, Y and Z axes measured by a gyroscope sensor are wirelessly transmitted from the mobile communication terminal to the external information device. A fourth input signal for the voice-to-text conversion can be transmitted wirelessly. During a multi-input operation in the external information device, an event signal for outputting a vibration or speaker sound is sent as an output signal to the mobile communication terminal.

### CROSS REFERENCE TO RELATED APPLICATIONS AND CLAIM OF PRIORITY

This patent application is a National Phase application under 35 U.S.C. §371 of International Application No. PCT/KR2011/001699, filed on Mar. 11, 2011, which claims priority to Korean Patent Application number 10-2010-0022201, filed on Mar. 12, 2010, entire contents of which are incorporated herein by reference.

### BACKGROUND

1. Field of the Invention

The present invention relates to a multi-input and multi-output apparatus using a mobile communication terminal and a method thereof.

2. Description of the Related Art

With the advancement in information processing technologies including memory and audio technologies, users of a variety of electric/electronic apparatuses such as an MP3 player, a cellular phone, a game console and the like request the apparatuses to provide further realistic interactions.

Accordingly, interest in a method of providing software and hardware environments that can transfer visual and tactile information further realistically, in addition to transfer of existing auditory information, is increased.

Recently, a light emitting diode (hereinafter, referred to as an LED), i.e., a visual element, is installed in a variety of electric/electronic devices, such as a game console or a computer, as an example of a sensing element, and LED driving apparatuses in which the LED responds to the content of a program while the program is used are proposed and used.

Generally, since such a conventional LED driving apparatus is simple so as to be controlled in a method of being turned on and off depending on the existence of a speaker output signal or a power signal, it is boring and fed up to use the apparatus for an extended period of time or repeatedly.

In addition, since such an apparatus responds to all kinds of audio signals generated by a computer or the apparatus, the apparatus is driven in the process of turning on and off the apparatus or by a noise or an unnecessary audio signal. Therefore, the apparatus does not appropriately respond to a sound effect of a real game or an application, and thus a feeling completely different from the sound of the game or application is transferred.

In order to meet such a requirement, recently, an image such as a level meter or the like is displayed on the screen of the main body of a portable apparatus for playing back music so that the image may vary depending on the genre or sounds of the music, or a technique of flickering an LED installed in an accessory earphone-microphone while a user communicates or listens to music is pre-registered in Korean Utility Registration No. 20-0364457.

However, since the flickering intervals are adjusted to be constant, the flickering does not match to the sound effect.

In addition, since a pattern file of a conventional tactile apparatus such as a haptic apparatus is formed to be appropriate only to a tactile sensing element (e.g., a vibration motor or an actuator), the pattern file cannot be used when the pattern file is applied to other application apparatuses of an electric/electronic device.

A large number of Nintendo game consoles are released currently in order to solve this problem.

However, since the existing Nintendo game consoles are provided with a main body of the Nintendo game console and a Wii remote controller separately and configured in a method of being driven after connecting to an external information device, it is difficult to install, and additional devices should be provided separately. In addition, since an input device sends only one input signal, and an output signal for outputting a vibration sound or a speaker sound to the input device does not exist, interest in the game gradually fades away.

### SUMMARY

Therefore, one or more embodiments of the present invention has been made in view of the above problems, and it is an aspect of the present invention to provide a multi-input and multi-output apparatus using a mobile communication terminal and a method thereof, in which a multi-input control window one-to-one corresponding to an external information device can be set in the mobile communication terminal by a program and activated in a variety of ways depending on the type of multi-input operation through a multi-input mode application unit. A first input signal related to a touch screen, a second input signal related to an acceleration sensor and a third input signal corresponding to the location of the mobile communication terminal moving in the X-axis, Y-axis and Z-axis directions sensed by a gyroscope sensor can be wirelessly transmitted from the mobile communication terminal to the external information device depending on the state of multi-input operation. The mobile communication terminal provided with a voice recognition function converts voices into characters and wirelessly transmits a fourth input signal. Since the external information device may transmit an output signal to the mobile communication terminal while performing a multi-input operation so that an event signal may be outputted as a vibration sound or a speaker sound, a 3D atmosphere can be vividly experienced at the mobile communication terminal itself. The multi-input and multi-output apparatus is compatible with an external information device regardless of time and space through the mobile communication terminal and can be used by changing a mode into a gaming joystick, a wireless mouse, a wireless keyboard, a smart key for vehicle, a remote controller for controlling an appliance, or a voice recognition converter.

In order to accomplish the above aspect of the invention, according to one aspect of the invention, there is provided a multi-input and multi-output apparatus using a mobile communication terminal, the apparatus including: an external information device 100 for displaying a specific screen on a display of the external information device, controlling a position and operation of the mobile communication terminal in one-to-one correspondence with a multi-input signal transferred from the mobile communication terminal, and outputting an event signal generated on the display to the mobile communication terminal through a bi-directional data communication unit; and the mobile communication terminal 200 including a smart input-output module 210 for transmitting the multi-input signal inputted from a touch screen, an acceleration sensor, a gyroscope sensor or a voice recognition unit to the external information device, receiving the event signal generated on the display from the external information device and transmitting the event signal to a sensing element.

### BRIEF DESCRIPTION OF THE DRAWINGS

FIG. 1 is a view showing configuration of constitutional components of a multi-input and multi-output apparatus using a mobile communication terminal according to an embodiment of the present invention.

FIG. 2 is a block diagram showing constitutional components of an external information device 100 according to an embodiment of the present invention.

FIG. 3 is a block diagram showing constitutional components of a smart input-output module 210 according to an embodiment of the present invention.

FIG. 4 is a block diagram showing constitutional components of a smart multi-input mode control unit 219 according to an embodiment of the present invention.

FIG. 5 is a block diagram showing constitutional components of a multi-input mode application unit 219a according to an embodiment of the present invention.

FIG. 6 is a view showing the operating procedure of a gaming joystick input mode according to an embodiment of the present invention, in which operation of an external information device is controlled one-to-one by setting a mobile communication terminal as a gaming joystick of 3D atmosphere based on a first input signal setting unit, a second input signal setting unit, a third input signal setting unit, a fourth input signal setting unit, a first output signal setting unit and a second output signal setting unit.

FIG. 7 is a flowchart illustrating a multi-input and multi-output method using a mobile communication terminal according to an embodiment of the present invention.

FIG. 8 is a flowchart illustrating a specific process of executing an application related to a multi-input mode using a base-band chip and a multimedia chip of a mobile communication terminal in a multi-input mode application unit of a smart multi-input mode control unit according to an embodiment of the present invention.

### DETAILED DESCRIPTION

Hereinafter, exemplary embodiments of the present invention will be described with reference to the accompanying drawings.

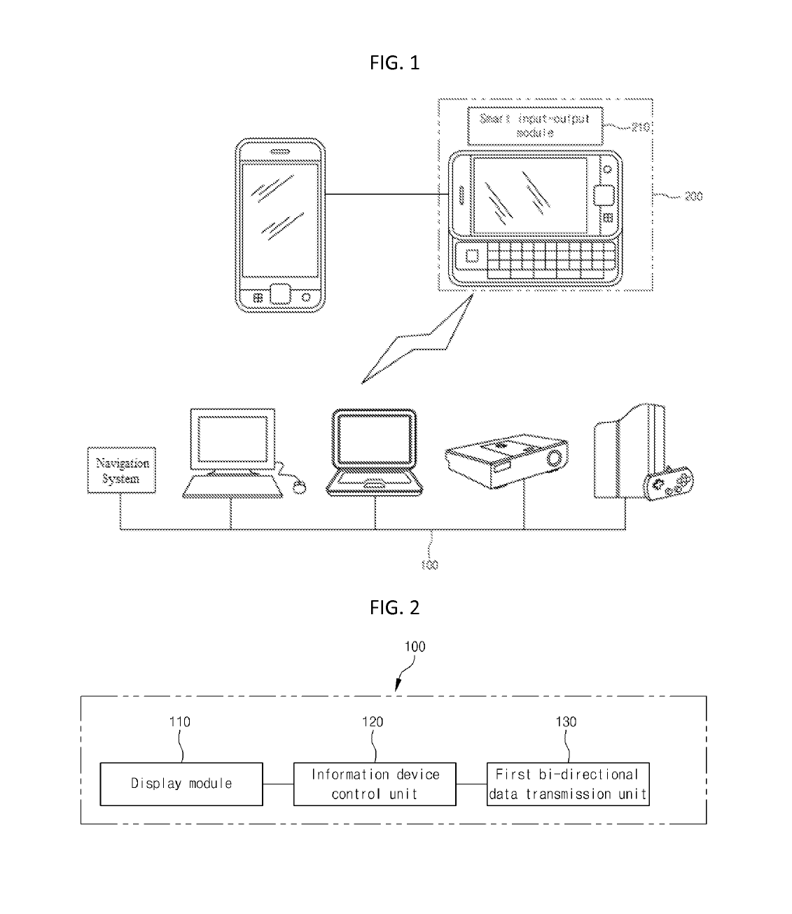

FIG. 1 is a view showing configuration of constitutional components of a multi-input and multi-output apparatus using a mobile communication terminal according to an embodiment of the present invention, and the multi-input and multi-output apparatus includes an external information device 100, a mobile communication terminal 200 and a smart input-output module 210 embedded in the mobile communication terminal.

First, the external information device 100 according to an embodiment of the present invention will be described.

The external information device displays a specific screen, controls the position and operation of the mobile communication terminal in one-to-one correspondence with a multi-input signal transferred from the mobile communication terminal, and outputs an event signal generated on a display to the mobile communication terminal through a bi-directional data communication unit, and the external information device is configured by selecting any one of multimedia devices including an appliance (an LCD TV, an LED TV, a refrigerator or an air conditioner), a 3D gaming monitor, a vehicle, a PC monitor, a notebook computer, a tablet PC, a beam projector, a navigation system and the like.

As shown in FIG. 2, the external information device 100 according to an embodiment of the present invention includes a display module 110, an information device control unit 120 and a first bi-directional data transmission unit 130.

The display module 110 displays a multi-input screen.

The information device control unit 120 controls the position and operation of the mobile communication terminal on the multi-input screen in one-to-one correspondence when a multi-input or a variety application execution commands are inputted through a multi-input signal of the mobile communication terminal and controls to transmit an output signal to a sensing element of the mobile communication terminal depending on an event signal generated on the display.

An example of the information device control unit 120 is configured of a PIC16C711 chip.

The first bi-directional data transmission unit 130 receives the multi-input signal of the mobile communication terminal 200 and transmits the event signal to the mobile communication terminal 200 according to a control signal of the information device control unit.

This is accomplished by selecting any one of a method of pairing with and connecting to the mobile communication terminal through a Bluetooth scheme, a method of connecting to the mobile communication terminal using a radio frequency (RF), a method of connecting to the mobile communication terminal using a wireless Internet network (WiFi), a method of connecting to the mobile communication terminal using an ultra wide band (UWB), and a method of connecting to the mobile communication terminal using an RF technique supported in a personal area network (PAN) environment.

Next, the mobile communication terminal 200 according to an embodiment of the present invention is described.

The mobile communication terminal 200 is embedded with the smart input-output module 210 for transmitting a variety of multi-input signals inputted from a touch screen, an acceleration sensor, a gyroscope sensor and a voice recognition unit to the external information device, receiving an event signal generated on the display from the external information device and transmitting the event signal to a sensing element. The mobile communication terminal 200 is a cellular phone provided with functions such as searching for information from the Internet, transmitting and receiving image information and the like, which has features of a portable computer and is capable of performing Internet communication and facsimile transmission while moving.

An example of the mobile communication terminal according to an embodiment of the present invention is a personal data assistant digital (PDA), a smart phone, a portable multimedia player (PDP), a mobile communication future phone, or the like.

The mobile communication terminal according to an embodiment of the present invention includes a vibration element, a speaker element, a gyroscope sensor, an acceleration sensor and a voice recognition unit, and a touch screen is configured on a screen window.

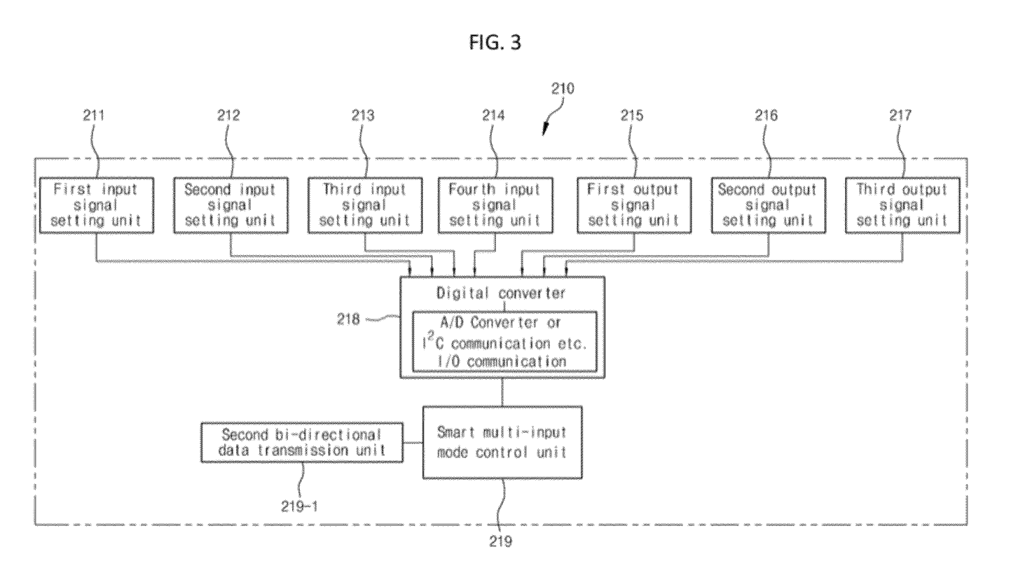

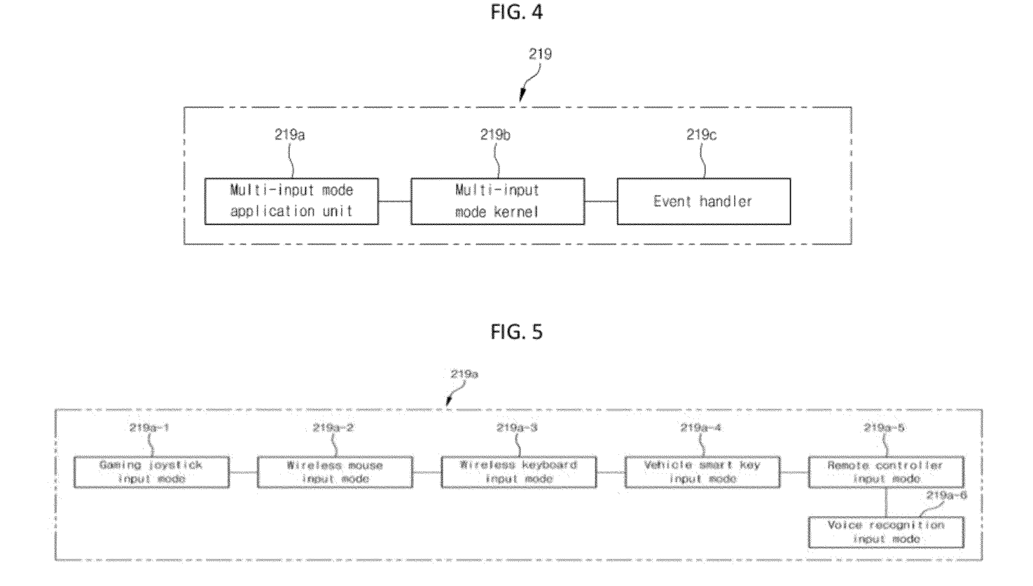

As shown in FIG. 3, the smart input-output module 210 includes a first input signal setting unit 211, a second input signal setting unit 212, a third input signal setting unit 213, a fourth input signal setting unit 214, a first output signal setting unit 215, a second output signal setting unit 216, a third output signal setting unit 217, a digital converter 218, a smart multi-input mode control unit 219 and a second bi-directional data transmission unit 219-1.

The first input signal setting unit 211 is connected to the touch screen of the mobile communication terminal through a program and sets a signal inputted from the touch screen as a first input signal, and it transfers the first input signal inputted from the touch screen to the smart multi-input mode control unit 219.

The second input signal setting unit 212 is connected to the acceleration sensor of the mobile communication terminal through a program and sets an acceleration input signal of the mobile communication terminal inputted from the acceleration sensor as a second input signal, and it transfers the second input signal inputted from the acceleration sensor to the smart multi-input mode control unit 219.

The third input signal setting unit 213 is connected to the gyroscope sensor of the mobile communication terminal through a program and sets a position signal of the mobile communication terminal moving in the X-axis, Y-axis and Z-axis directions sensed by the gyroscope sensor as a third input signal, and it transfers the third input signal inputted from the gyroscope sensor to the smart multi-input mode control unit 219.

The fourth input signal setting unit 214 is connected to the voice recognition unit 214a of the mobile communication terminal through a program and sets a voice recognition signal inputted from the voice recognition unit as a fourth input signal, and it transfers the fourth input signal inputted from the voice recognition unit to the smart multi-input mode control unit 219.

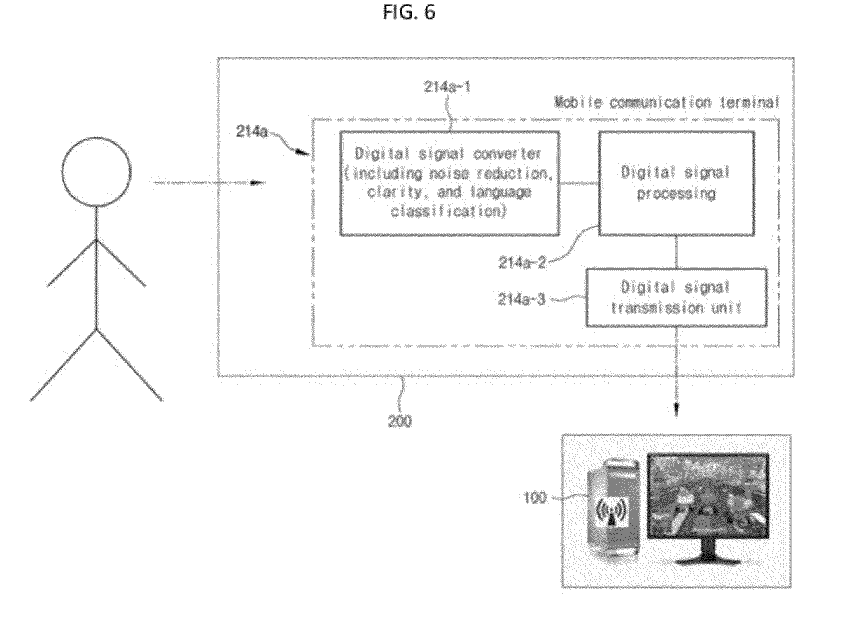

The voice recognition unit analyzes a voice language spoken by a person using a computer and converts the voice language into character data. As shown in FIG. 6, the voice recognition unit 214a recognizes the voice language spoken by a person, removes noises using a digital signal converter 214a-1, processes the voice language into digital signals using a digital signal processing unit 214a-2 and transmits the digital signals to the external information device through a digital signal transmission unit 214a-3.

The first output signal setting unit 215 sets an output signal for outputting a vibration signal among event signals generated on the display of the external information device to a vibration element, i.e., a sensing element, as a first output signal, and it outputs an event signal generated by the external information device while performing a multi-input operation as a vibration.

The second output signal setting unit 216 sets an output signal for outputting a sound signal among event signals generated on the display of the external information device to a speaker element, i.e., a sensing element, as a second output signal, and it outputs an event signal generated by the external information device while performing a multi-input operation as a sound.

The third output signal setting unit 217 sets an output signal for outputting a flickering signal among event signals generated on the display of the external information device to a backlight unit embedded in the screen of the mobile communication terminal as a third output signal, and it outputs an event signal generated by the external information device while performing a multi-input operation as flickering of the screen of the mobile communication terminal.

The digital converter 218 converts an analog signal inputted from the first input signal setting unit 211, the second input signal setting unit 212, the third input signal setting unit 213 or the fourth input signal setting unit 214 into a digital signal or directly communicates with the external information device using I²C communication.

Here, I²C is a serial computer bus developed by Philips, which is used to connect the mobile communication terminal and the external information device. I²C is the abbreviation of Inter-Integrated Circuit and is pronounced as eye-square-cee.

I²C uses two bi-directional open collector lines referred to as a serial data (SDA) and a serial clock (SCL) connected with a pull-up resistor. Its maximum voltage is +5V, and a +3.3V system is generally used, but other voltages may be used.

The I²C reference design has an address space of 7 bits, and since 16 of the address space are reserved, 112 nodes can be connected to the same bus in maximum.

The mode of the I²C bus used in an embodiment of the present invention includes a standard mode of 100 Kbit/s and a low-speed mode of 10 Kbit/s.

I²C of the latest revision operates further faster and supports a fast mode of 400 Kbit/s and a high-speed mode of 3.4 Mbit/s. It supports extended functions such as 10-bit address assignment capable of connecting up to 1008 nodes in maximum.

The smart multi-input mode control unit 219 controls to convert the digital signal converted by the digital converter 218 into a coded form that can be recognized by the external information device 100, switches the mobile communication terminal 200 to a multi-input mode based on the first input signal setting unit 211, the second input signal setting unit 212, the third input signal setting unit 213, the fourth input signal setting unit 214, the first output signal setting unit 215, the second output signal setting unit 216 and the third output signal setting unit 217, and controls the touch screen, the acceleration sensor, the gyroscope sensor, the vibration element and the speaker element based on the multi-input mode. As shown in FIG. 4, the smart multi-input mode control unit 219 includes a multi-input mode application unit 219a, a multi-input mode kernel 219b and an event handler 219c.

The multi-input mode application unit 219a executes a multi-input mode in the mobile communication terminal 200 and activates a control window on the screen of the mobile communication terminal 200 so that the external information device may be controlled one-to-one.

As shown in FIG. 5, the multi-input mode application unit 219a includes a gaming joystick input mode 219a-1, a wireless mouse input mode 219a-2, a wireless keyboard input mode 219a-3, a vehicle smart key input mode 219a-4, a remote controller input mode 219a-5, and a voice recognition input mode 219a-6.

The gaming joystick input mode 219a-1 controls operation of the external information device 100 one-to-one by setting the mobile communication terminal 200 as a gaming joystick of 3D atmosphere based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

The wireless mouse input mode 219a-2 controls operation of the external information device 100 one-to-one by setting the mobile communication terminal 200 as a wireless mouse of a PC based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

The wireless keyboard input mode 219a-3 controls operation of the external information device 100 one-to-one by setting the mobile communication terminal 200 as a wireless keyboard of a PC based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

The vehicle smart key input mode 219a-4 controls operation of the external information device 100 one-to-one by setting the mobile communication terminal 200 as a smart key of a vehicle based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

The remote controller input mode 219a-5 controls operation of the external information device 100 one-to-one by setting the mobile communication terminal 200 as a remote controller for controlling an appliance based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

The voice recognition input mode 219a-6 controls operation of the external information device 100 one-to-one by setting the mobile communication terminal 200 as a voice recognition input means based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

The multi-input mode kernel 219b provides a control window interface of the multi-input mode application unit 219a, one-to-one corresponding to a multi-input screen displayed on the external information device 100.

The event handler 219c stores the event signal received from the external information device 100 and outputs the event signal to a sensing element by calling a sensing element algorithm corresponding to each event.

The second bi-directional data transmission unit 219-1 receives the event signal from the external information device 100 depending on a control signal of the smart multi-input mode control unit 219 and transmits a multi-input signal of the mobile communication terminal 200 to the external information device 100.

This is accomplished by selecting any one of a method of pairing with and connecting to the mobile communication terminal 200 through a Bluetooth scheme, a method of connecting to the mobile communication terminal 200 using an RF, a method of connecting to the mobile communication terminal 200 using a wireless Internet network (WiFi), a method of connecting to the mobile communication terminal 200 using a UWB, and a method of connecting to the mobile communication terminal 200 using an RF technique supported in a PAN environment.

In addition, the smart input-output module 210 may include a fifth input signal setting unit for setting an input signal related to a keypad inputted through a qwerty keyboard as a fifth input signal, in addition to the first input signal setting unit 211, the second input signal setting unit 212, the third input signal setting unit 213 and the fourth input signal setting unit 214.

Hereinafter, the specific operating procedure of the multi-input and multi-output method using a mobile communication terminal 200 according to an embodiment of the present invention will be described.

First, the multi-input mode application unit 219a of the smart multi-input mode control unit 219 executes an application related to a multi-input mode in an environment capable of executing the application in the mobile communication terminal (S100).

Next, the mobile communication terminal 200 searches for an external information device 100 capable of performing a multi-input operation (S200).

Next, a searched external information device 100 transmits a multi-input authentication code to the mobile communication terminal 200 (S300).

Next, after receiving the multi-input authentication code of the external information device 100, the mobile communication terminal 200 drives the multi-input mode application unit 219a of the smart multi-input mode control unit 219 and selects a multi-input mode corresponding to the multi-input authentication code (S400).

At this point, the multi-input mode application unit 219a of the smart multi-input mode control unit 219 is driven in the steps described below.

The smart multi-input mode control unit 219 switches the mobile communication terminal 200 into a software update mode or drives a daemon file related to software update (S410).

Subsequently, the smart multi-input mode control unit 219 checks validity of update software and a mobile device downloading the update software (S420).

Subsequently, a base band chip and a multimedia chip of the mobile communication terminal 200 receive an information file related to software that will be updated (S430).

Subsequently, the smart multi-input mode control unit 219 receives a terminal type supported by the software and driving information related to the terminal type through the update information and checks whether or not the software driven in the mobile communication terminal 200 is compatible software (S440).

Subsequently, the mobile communication terminal 200 receives binary data of the software transmitted from the smart multi-input mode control unit 219 (S450).

Subsequently, after receiving the software, the mobile communication terminal 200 installs upload of the software (S460).

Next, if the mobile communication terminal 200 selects a multi-input mode, the external information device 100 also activates a corresponding multi-input screen and synchronizes the mobile communication terminal 200 and the external information device 100 (S500).

Next, the external information device 100 outputs an event signal generated while displaying the multi-input screen to the mobile communication terminal 200 through a bi-directional data communication unit (S600).

Next, the mobile communication terminal 200 receives the event signal generated on the display of the external information device 100 from the external information device 100 and outputs the event signal to a sensing element (S700).

Finally, if a multi-input mode end button is pressed, the normal connection related to the multi-input between the mobile communication terminal and the external information device is terminated (S800).

Hereinafter, the specific operating procedures of the gaming joystick input mode 219a-1, the wireless mouse input mode 219a-2, the wireless keyboard input mode 219a-3, the vehicle smart key input mode 219a-4, the remote controller input mode 219a-5, and the voice recognition input mode 219a-6 among the multi-input and multi-output methods using a mobile communication terminal 200 according to the present invention will be described as embodiments of the present invention.

[Gaming Joystick Input Mode]

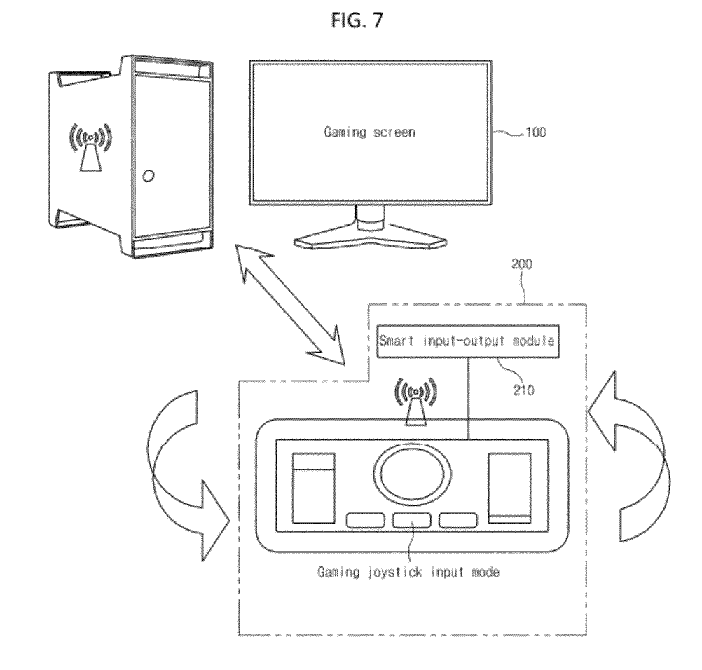

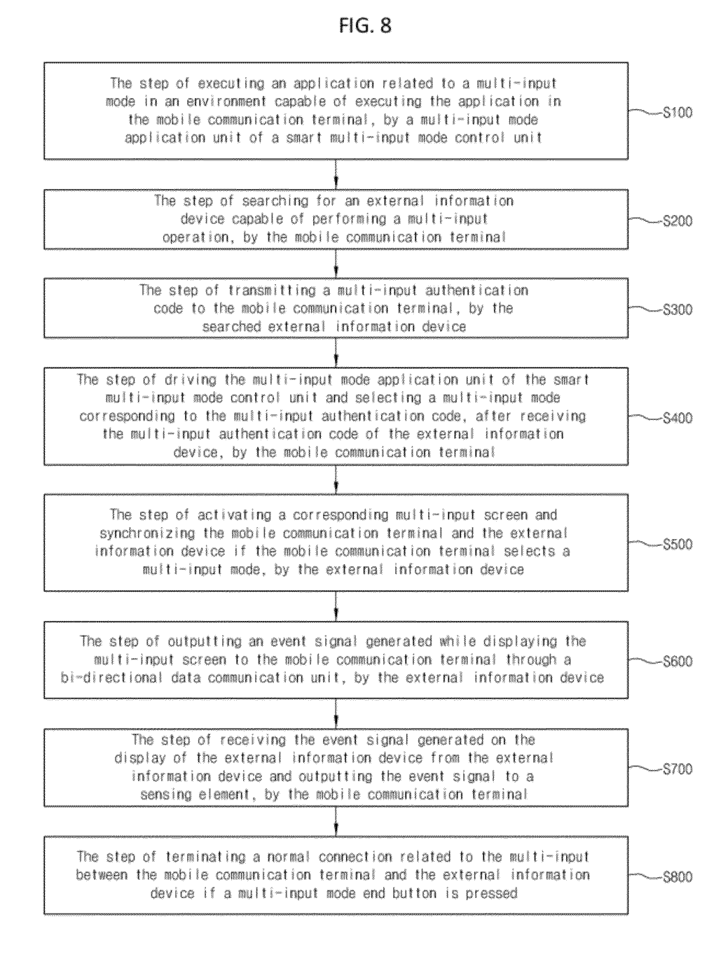

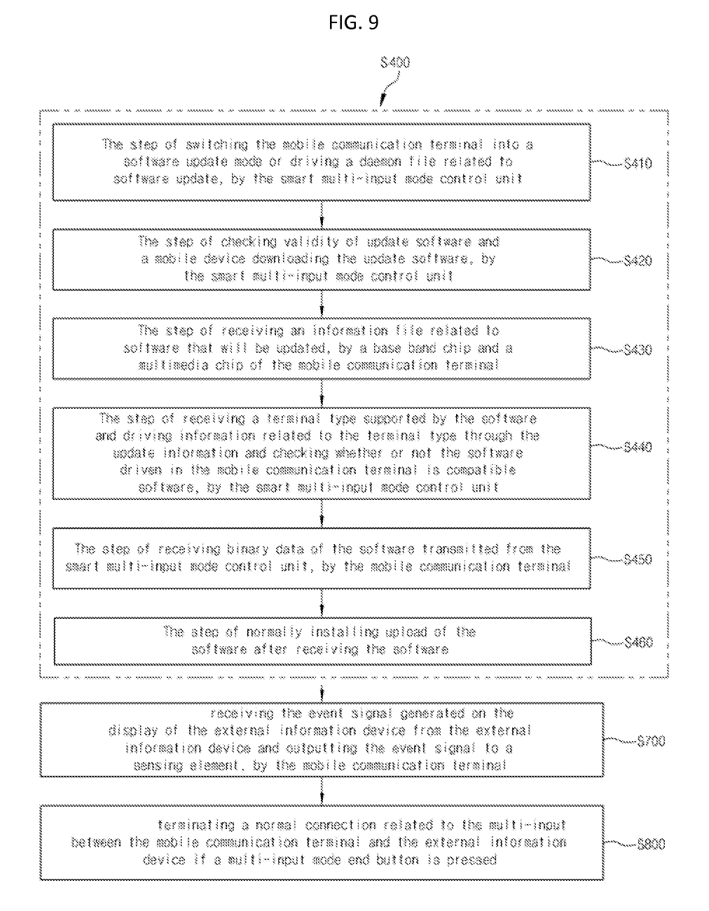

As shown in FIG. 7, the gaming joystick input mode is an input mode for controlling operation of the external information device 100 one-to-one by setting the mobile communication terminal 200 as a gaming joystick of 3D atmosphere based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

Here, the external information device 100 is assumed to be configured as a 3D gaming monitor.

That is, the mobile communication terminal 200 searches for a 3D gaming monitor among external information devices 100 capable of performing a multi-input operation.

Subsequently, a searched 3D gaming monitor transmits a multi-input authentication code to the mobile communication terminal 200.

Subsequently, after receiving the multi-input authentication code of the 3D gaming monitor, the mobile communication terminal 200 drives the multi-input mode application unit 219a of the smart multi-input mode control unit 219 and selects the gaming joystick input mode corresponding to the multi-input authentication code of the 3D gaming monitor.

Subsequently, if the mobile communication terminal 200 selects the gaming joystick input mode, the 3D gaming monitor also activates a corresponding multi-input screen and synchronizes the mobile communication terminal 200 and the 3D gaming monitor 100.

Subsequently, the 3D gaming monitor 100 outputs an event signal generated while displaying the multi-input screen to the mobile communication terminal 200 through the bi-directional data communication unit.

Subsequently, the mobile communication terminal 200 receives the event signal generated on the display from the 3D gaming monitor and outputs the event signal to a sensing element.

Finally, if a gaming joystick input mode end button is pressed, the normal connection related to the multi-input between the mobile communication terminal and the 3D gaming monitor is terminated.

[Wireless Mouse Input Mode]

The wireless mouse input mode is an input mode for controlling operation of the external information device 100 one-to-one by setting the mobile communication terminal 200 as a wireless mouse of a PC based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

Here, the external information device 100 is assumed to be configured as a main body and a monitor of a PC.

That is, the mobile communication terminal 200 searches for a main body of a PC among external information devices 100 capable of performing a multi-input operation.

Subsequently, a searched main body of a PC transmits a multi-input authentication code to the mobile communication terminal 200.

Subsequently, after receiving the multi-input authentication code of the main body of a PC, the mobile communication terminal 200 drives the multi-input mode application unit 219a of the smart multi-input mode control unit 219 and selects the wireless mouse input mode corresponding to the multi-input authentication code of the main body of a PC.

Subsequently, if the mobile communication terminal 200 selects the wireless mouse input mode, the main body of a PC also activates a corresponding multi-input screen and synchronizes the mobile communication terminal 200 and the main body of a PC.

Subsequently, the main body of a PC outputs an event signal generated while displaying the multi-input screen to the mobile communication terminal 200 through the bi-directional data communication unit.

Subsequently, the mobile communication terminal 200 receives the event signal generated on the display from the main body of a PC and outputs the event signal to a sensing element.

Finally, if a wireless mouse input mode end button is pressed, the normal connection related to the multi-input between the mobile communication terminal and the main body of a PC is terminated.

[Wireless Keyboard Input Mode]

The wireless keyboard input mode is an input mode for controlling operation of the external information device 100 one-to-one by setting the mobile communication terminal 200 as a wireless keyboard of a PC based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

Here, the external information device 100 is assumed to be configured as a main body and a monitor of a PC.

That is, the mobile communication terminal 200 searches for a main body of a PC among external information devices 100 capable of performing a multi-input operation.

Subsequently, a searched main body of a PC transmits a multi-input authentication code to the mobile communication terminal 200.

Subsequently, after receiving the multi-input authentication code of the main body of a PC, the mobile communication terminal 100 drives the multi-input mode application unit 219a of the smart multi-input mode control unit 219 and selects the wireless keyboard input mode corresponding to the multi-input authentication code of the main body of a PC.

Subsequently, if the mobile communication terminal 200 selects the wireless keyboard input mode, the main body of a PC also activates a corresponding multi-input screen and synchronizes the mobile communication terminal 200 and the main body of a PC.

Subsequently, the main body of a PC outputs an event signal generated while displaying the multi-input screen to the mobile communication terminal 200 through the bi-directional data communication unit.

Subsequently, the mobile communication terminal 200 receives the event signal generated on the display from the main body of a PC and outputs the event signal to a sensing element.

Finally, if a wireless keyboard input mode end button is pressed, the normal connection related to the multi-input between the mobile communication terminal and the main body of a PC is terminated.

[Vehicle Smart Key Input Mode]

The vehicle smart key input mode is an input mode for controlling operation of the external information device 100 one-to-one by setting the mobile communication terminal 200 as a vehicle smart key based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

Here, the external information device 100 is assumed to be configured as a vehicle.

The vehicle smart key is a wireless remote control apparatus having a remote start function, a preheating function, an automatic door lock/unlock function (← a remote entry function) and an anti-theft function of a vehicle.

In an embodiment of the present invention, the vehicle smart key input mode is activated through a control window of the mobile communication terminal 200 in order to set the mobile communication terminal 200 as the vehicle smart key.

That is, the mobile communication terminal 200 searches for a vehicle among external information devices capable of performing a multi-input operation.

Subsequently, a searched vehicle transmits a multi-input authentication code to the mobile communication terminal 200.

Subsequently, after receiving the multi-input authentication code of the vehicle, the mobile communication terminal 200 drives the multi-input mode application unit 219a of the smart multi-input mode control unit 219 and selects the vehicle smart key input mode corresponding to the multi-input authentication code of the vehicle.

Subsequently, if the mobile communication terminal 200 selects the vehicle smart key input mode, the vehicle also activates a corresponding multi-input screen and synchronizes the mobile communication terminal 200 and the vehicle.

Subsequently, the vehicle outputs an event signal generated while displaying the multi-input screen to the mobile communication terminal 200 through the bi-directional data communication unit.

Subsequently, the mobile communication terminal 200 receives the event signal generated on the display from the vehicle and outputs the event signal to a sensing element.

Finally, if a vehicle smart key input mode end button is pressed, the normal connection related to the multi-input between the mobile communication terminal and the vehicle is terminated.

[Remote Controller Input Mode]

The remote controller input mode is an input mode for controlling operation of the external information device 100 one-to-one by setting the mobile communication terminal 200 as a remote controller for controlling an appliance based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

Here, the external information device 100 is assumed to be configured as an air conditioner.

That is, the mobile communication terminal 200 searches for an air conditioner among external information devices 100 capable of performing a multi-input operation.

Subsequently, a searched air conditioner transmits a multi-input authentication code to the mobile communication terminal 200.

Subsequently, after receiving the multi-input authentication code of the air conditioner, the mobile communication terminal 200 drives the multi-input mode application unit 219a of the smart multi-input mode control unit 219 and selects the remote controller input mode corresponding to the multi-input authentication code of the air conditioner.

Subsequently, if the mobile communication terminal 200 selects the remote controller input mode, the air conditioner (← vehicle) also activates a corresponding multi-input screen and synchronizes the mobile communication terminal and the air conditioner.

Subsequently, the air conditioner outputs an event signal generated while displaying the multi-input screen to the mobile communication terminal 200 through the bi-directional data communication unit.

Subsequently, the mobile communication terminal 200 receives the event signal generated on the display from the air conditioner and outputs the event signal to a sensing element.

Finally, if a remote controller input mode end button is pressed, the normal connection related to the multi-input between the mobile communication terminal and the air conditioner (← vehicle) is terminated.

[Voice Recognition Input Mode]

The voice recognition input mode is an input mode for controlling operation of the external information device 100 one-to-one by setting the mobile communication terminal 200 as a voice recognition input means based on the first input signal setting unit 211, the second input signal setting unit 212, the third input signal setting unit 213, the fourth input signal setting unit 214, the first output signal setting unit 215, the second output signal setting unit 216 and the third output signal setting unit 217.

Here, the external information device is assumed to be configured as a navigation system.

That is, the mobile communication terminal 200 searches for a navigation system among external information devices 100 capable of performing a multi-input operation.

Subsequently, a searched navigation system transmits a multi-input authentication code to the mobile communication terminal 200.

Subsequently, after receiving the multi-input authentication code of the navigation system, the mobile communication terminal 200 drives the multi-input mode application unit 219a of the smart multi-input mode control unit 219 and selects the voice recognition input mode corresponding to the multi-input authentication code of the navigation system.

Subsequently, if the mobile communication terminal 200 selects the voice recognition input mode, the navigation system also activates a corresponding multi-input screen and synchronizes the mobile communication terminal 200 and the navigation system.

Subsequently, the navigation system outputs an event signal generated while displaying the multi-input screen to the mobile communication terminal through the bi-directional data communication unit.

Subsequently, the mobile communication terminal 200 receives the event signal generated on the display from the navigation system and outputs the event signal to the sensing element.

Finally, if a voice recognition input mode end button is pressed, the normal connection related to the multi-input between the mobile communication terminal and the navigation system is terminated.

As described above, a multi-input control window one-to-one corresponding to an external information device can be set in the mobile communication terminal by a program and activated in a variety of ways depending on the type of multi-input operation through a multi-input mode application unit. A multi-input signal can be wirelessly transmitted depending on the state of multi-input operation. Since the external information device may transmit an output signal to the mobile communication terminal while performing a multi-input operation so that an event signal may be outputted as a vibration sound or a speaker sound, the multi-input operation can be vividly experienced in a 3D atmosphere. The multi-input and multi-output apparatus is compatible with an external information device regardless of time and space through the mobile communication terminal and can be used as a multi-input joystick.

In the present invention, the mobile communication terminal is compatible with an external information device and can be used as a multi-input and multi-output device. Accordingly, since an event signal of a vibration or a sound of the external information device may be outputted through the mobile communication terminal, a 3D atmosphere can be vividly experienced using the mobile communication terminal. Furthermore, the present invention is industrially applicable since the mobile communication terminal can be used to control external information devices.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A multi-input and multi-output apparatus using a mobile communication terminal, the apparatus comprising:
an external information device for displaying a specific screen on a display of the external information device, controlling a position and operation of the mobile communication terminal in one-to-one correspondence with a multi-input signal transferred from the mobile communication terminal, and outputting an event signal generated on the display to the mobile communication terminal through a bi-directional data communication unit; and
the mobile communication terminal including a smart input-output module for transmitting the multi-input signal inputted from a touch screen, an acceleration sensor, a gyroscope sensor, a voice recognition unit, or a combination thereof to the external information device, receiving the event signal generated on the display from the external information device and transmitting the event signal to a sensing element.

2. The apparatus according to claim 1, wherein the smart input-output module comprises:
a first input signal setting unit connected to the touch screen of the mobile communication terminal through a program and setting a signal inputted from the touch screen as a first input signal;
a second input signal setting unit connected to the acceleration sensor of the mobile communication terminal through a program and setting an acceleration input signal of the mobile communication terminal inputted from the acceleration sensor as a second input signal;
a third input signal setting unit connected to the gyroscope sensor of the mobile communication terminal through a program and setting a position signal of the mobile communication terminal moving in the X-axis, Y-axis and Z-axis directions sensed by the gyroscope sensor as a third input signal;
a fourth input signal setting unit connected to the voice recognition unit of the mobile communication terminal through a program and setting a voice recognition signal inputted from the voice recognition unit as a fourth input signal;
a first output signal setting unit for setting an output signal for outputting a vibration signal among event signals generated on the display of the external information device to a vibration element of the sensing element as a first output signal;
a second output signal setting unit for setting an output signal for outputting a sound signal among the event signals generated on the display of the external information device to a speaker element of the sensing element as a second output signal;
a third output signal setting unit for setting an output signal for outputting a flickering signal among the event signals generated on the display of the external information device to a backlight unit embedded in the screen of the mobile communication terminal as a third output signal;
a digital converter for converting an analog signal inputted from the first input signal setting unit, the second input signal setting unit, the third input signal setting unit or the fourth input signal setting unit into a digital signal;
a smart multi-input mode control unit for controlling to convert the digital signal converted by the digital converter into a coded form that can be recognized by the external information device, switching the mobile communication terminal to a multi-input mode based on the first input signal setting unit, the second input signal setting unit, the third input signal setting unit, the fourth input signal setting unit, the first output signal setting unit, the second output signal setting unit and the third output signal setting unit, and controlling the touch screen, the acceleration sensor, the gyroscope sensor, the vibration element and the speaker element based on the multi-input mode; and
a second bi-directional data transmission unit for receiving the event signal from the external information device depending on a control signal of the smart multi-input mode control unit and transmitting the multi-input signal of the mobile communication terminal to the external information device.

3. The apparatus according to claim 2, wherein the smart multi-input mode control unit includes:
a multi-input mode application unit for executing the multi-input mode in the mobile communication terminal and activating a control window on the screen of the mobile communication terminal so that the external information device may be controlled one-to-one;
a multi-input mode kernel for providing a control window interface of the multi-input mode application unit, one-to-one corresponding to a multi-input screen displayed on the external information device; and
an event handler for storing the event signal received from the external information device and outputting the event signal to a sensing element by calling a sensing element algorithm corresponding to each event.

4. The apparatus according to claim 3, wherein the multi-input mode application unit comprises:
a gaming joystick input mode for controlling operation of the external information device one-to-one by setting the mobile communication terminal as a gaming joystick of 3D atmosphere based on the first input signal setting unit, the second input signal setting unit, the third input signal setting unit, the fourth input signal setting unit, the first output signal setting unit, the second output signal setting unit and the third output signal setting unit;
a wireless mouse input mode for controlling operation of the external information device one-to-one by setting the mobile communication terminal as a wireless mouse of a PC based on the first input signal setting unit, the second input signal setting unit, the third input signal setting unit, the fourth input signal setting unit, the first output signal setting unit, the second output signal setting unit and the third output signal setting unit;
a wireless keyboard input mode for controlling operation of the external information device one-to-one by setting the mobile communication terminal as a wireless keyboard of a PC based on the first input signal setting unit, the second input signal setting unit, the third input signal setting unit, the fourth input signal setting unit, the first output signal setting unit, the second output signal setting unit and the third output signal setting unit;
a vehicle smart key input mode for controlling operation of the external information device one-to-one by setting the mobile communication terminal as a smart key of a vehicle based on the first input signal setting unit, the second input signal setting unit, the third input signal setting unit, the fourth input signal setting unit, the first output signal setting unit, the second output signal setting unit and the third output signal setting unit;
a remote controller input mode for controlling operation of the external information device one-to-one by setting the mobile communication terminal as a remote controller for controlling an appliance based on the first input signal setting unit, the second input signal setting unit, the third input signal setting unit, the fourth input signal setting unit, the first output signal setting unit, the second output signal setting unit and the third output signal setting unit; and
a voice recognition input mode for controlling operation of the external information device one-to-one by setting the mobile communication terminal as a voice recognition input means based on the first input signal setting unit, the second input signal setting unit, the third input signal setting unit, the fourth input signal setting unit, the first output signal setting unit, the second output signal setting unit and the third output signal setting unit.

5. The apparatus according to claim 1, wherein the external information device comprises:
a display module for displaying a multi-input screen;
an information device control unit for controlling a position and operation of the mobile communication terminal on the multi-input screen in one-to-one correspondence when a multi-input or an application execution command is inputted through the multi-input signal of the mobile communication terminal and controlling to transmit an output signal to the sensing element of the mobile communication terminal depending on the event signal generated on the display; and
a first bi-directional data transmission unit for receiving the multi-input signal of the mobile communication terminal and transmitting the event signal to the mobile communication terminal according to a control signal of the information device control unit.

6. A multi-input and multi-output method using a mobile communication terminal, the method comprising:
executing an application related to a multi-input mode in an environment capable of executing the application in the mobile communication terminal, by a multi-input mode application unit of a smart multi-input mode control unit;
searching for an external information device capable of performing a multi-input operation, by the mobile communication terminal;
transmitting a multi-input authentication code to the mobile communication terminal, by the searched external information device;
driving the multi-input mode application unit of the smart multi-input mode control unit and selecting the multi-input mode corresponding to the multi-input authentication code, after receiving the multi-input authentication code of the external information device, by the mobile communication terminal;
activating a corresponding multi-input screen and synchronizing the mobile communication terminal and the external information device if the mobile communication terminal selects the multi-input mode, by the external information device;
outputting an event signal generated while displaying the multi-input screen to the mobile communication terminal through a bi-directional data communication unit, by the external information device;
receiving the event signal generated on the display of the external information device from the external information device and outputting the event signal to the sensing element, by the mobile communication terminal 200; and
terminating a connection related to the multi-input between the mobile communication terminal and the external information device if a multi-input mode end button is pressed.

7. The method according to claim 6, wherein said driving the multi-input mode application unit of the smart multi-input mode control unit comprises:
switching the mobile communication terminal into a software update mode or driving a daemon file related to software update, by the smart multi-input mode control unit;
checking validity of update software and a mobile device downloading the update software, by the smart multi-input mode control unit;
receiving an information file related to software that will be updated, by a base band chip and a multimedia chip of the mobile communication terminal;
receiving a terminal type supported by the software and driving information related to the terminal type through the update information and checking whether or not the software driven in the mobile communication terminal is compatible software, by the smart multi-input mode control unit;
receiving binary data of the software transmitted from the smart multi-input mode control unit, by the mobile communication terminal; and
normally installing upload of the software after receiving the software.
